(19) United States
(12) Patent Application Publication
(10) Pub. No.: US 2007/0163109 A1
(43) Pub. Date: Jul. 19, 2007

(54) Strip for integrated circuit packages having a maximized usable area

(76) Inventors: Hem Takiar, Fremont, CA (US); Manickam Thavarajah, San Jose, CA (US); Ken Jian Ming Wang, San Francisco, CA (US); Chih-Chin Liao, Changhua (TW); Andre McKenzie, Pleasanton, CA (US); Shrikar Bhagath, San Jose, CA (US); Han-Shiao Chen, Da-an Township (TW); Chin-Tien Chiu, Taichung City (TW)

Correspondence Address: VIERRA MAGEN/SANDISK CORPORATION, 575 MARKET STREET, SUITE 2500, SAN FRANCISCO, CA, 94105, US

(21) Appl. No.: 11/321,426

(22) Filed: Dec. 29, 2005

(51) Int. Cl. H01R 43/00

(52) U.S. Cl. 29/825

(57) ABSTRACT

A strip on which a plurality of integrated circuit package outlines may be fabricated within a plurality of process tools. The strip includes one or more fiducial notches and/or guide pin notches formed in an outer edge of the strip. The one or more fiducial and/or guide pin notches allow a position of the strip to be identified within at least one process tool of the plurality of process tools. By forming the notches in the outer periphery of the strip, the usable area on the strip on which integrated circuit package outlines may be formed is increased. The strip may alternatively include conventional fiducial and/or guide pin holes, with the molding compound applied at least partially around the holes on one or more sides of the strip. The strip may further alternatively include fiducial holes filled with a translucent material that provides stability to the strip while allowing the strip to be used with an optical recognition sensor.

### BACKGROUND OF THE INVENTION

1. Field of the Invention

Embodiments of the present invention relate to strips for integrated circuit package outlines, the strips having a maximized usable area.

2. Description of the Related Art

The strong growth in demand for portable consumer electronics is driving the need for high-capacity storage devices. Non-volatile semiconductor memory devices, such as flash memory storage cards, are becoming widely used to meet the ever-growing demands on digital information storage and exchange. Their portability, versatility and rugged design, along with their high reliability and large capacity, have made such memory devices ideal for use in a wide variety of electronic devices, including for example digital cameras, digital music players, video game consoles, PDAs and cellular telephones.

While a number of packaging configurations are known, flash memory storage cards may in general be fabricated as system-in-a-package (SiP) or multichip modules (MCM), where a plurality of die are mounted on a substrate. The substrate may in general include a rigid base having a conductive layer etched on one or both sides. Electrical connections are formed between the die and the conductive layer(s), and the conductive layer(s) provide an electric lead structure for integration of the die into an electronic system. Once electrical connections between the die and substrate are made, one or both sides of the assembly are then typically encased in a molding compound to provide a protective package outline.

In view of the small form factor requirements, as well as the fact that flash memory cards need to be removable and not permanently attached to a printed circuit board, such cards are often built of a land grid array (LGA) package outline. In an LGA package outline, the semiconductor die is electrically connected to exposed contact fingers formed on a lower surface of the package outline. External electrical connection with other electronic components on a host printed circuit board is accomplished by bringing the contact fingers into pressure contact with complementary electrical pads on the printed circuit board. LGA memory package outlines are ideal for flash memory cards in that they have a smaller profile and lower inductance than pin grid array (PGA) and ball grid array (BGA) package outlines.

Significant economies of scale are achieved by forming a plurality of integrated circuit (IC) package outlines at the same time on panels. Once fabricated, the IC packages are separated from the panel, and those which pass inspection may then be enclosed within an outer plastic cover to form a completed flash memory card. A conventional IC package panel 20 is shown in top view in prior art FIG. 1. Panel 20 includes a plurality of IC package outlines 22. In order to orient the panel 20 and register a position of the panel within process tools for fabricating the finished chip packages, the panel 20 traditionally includes a plurality of fiducial holes 24 at the periphery of the panel 20.

In particular, when a panel is transferred into a process tool, such as for example a die bond tool, the panel is moved along the x-direction (with respect to the x-y coordinate system indicated in FIG. 1) until an optical recognition sensor registers the position of a first fiducial hole 24a of the fiducial holes 24. The optical recognition sensor may for example include a transmitter on one side of the panel emitting a beam to a receiver on the opposite side of the panel. When the hole is aligned with the optical sensor, the beam passes through the hole and is received within the receiver to register the position of the panel. Once a position of the panel is identified along the x-axis, the tool indexes the panel along the y-axis to process all IC package outlines within a given column. Once a column is completed, the panel is indexed back to the starting y-axis position, and then moved along the x-axis until the next fiducial hole, e.g., hole 24b registers with the optical sensor. This process is continued until the IC package outlines in each row and column have been processed within the tool. The panel may then be transferred to the next assembly tool in the fabrication process and the fiducial holes are again used to register a position of the panel with respect to equipment within the tool. Other fabrication schemes using fiducial holes 24 are known.

A panel 20 may further include guide pin holes 26. These holes receive pins to register and align the panel during an encapsulation process where the top and/or bottom of the panel are encapsulated in a molding compound to protect the individual IC packages. The guide pin holes 26 may also be used in a singulation process where the panel is singulated into the individual IC packages.

In conventional panels, the fiducial holes 24 and the pin holes 26 are located 2-3 mm in from at least the peripheral edge of the panel 20. Moreover, an additional boundary, or “keep out” area is provided between the fiducial holes 24 and pin holes 26 and IC package outlines formed on the panel. Consequently, conventional panels do not include any portion of the IC package outline at or near the edges. This space on conventional panels has gone unused.

### SUMMARY OF THE INVENTION

Embodiments of the present invention relate to a strip on which a plurality of integrated circuit packages may be fabricated within a plurality of process tools. The strip includes one or more fiducial notches and/or guide pin notches formed in an outer edge of the strip. The one or more fiducial and/or guide pin notches allow a position of the strip to be identified within at least one process tool of the plurality of process tools. By forming the notches in the outer periphery of the strip, the usable area on the strip on which integrated circuits package outlines may be formed is increased. The fiducial notches may be used with a conventional optical recognition sensor to register the position of the strip in fabrication processes such as die attach. The guide pin notches may be used with conventional guide pins to register the position of the strip in fabrication processes such as encapsulation and singulation.

In an alternative embodiment, the strip may include conventional fiducial and/or guide pin holes, with the molding compound applied at least partially around the fiducial and/or guide pin holes on one or more sides of the strip. In embodiments, a strip may include a combination of fiducial or guide pin holes surrounded by molding compound and fiducial or guide pin notches.

In a further embodiment, fiducial holes may be formed in the substrate, and then filled with a translucent material. The translucent material may be any of various materials, including for example translucent solder mask and/or translucent epoxy. By filling the fiducial holes with translucent material, the filled holes may be placed close to or at the edge of the strip without risk of the strip cracking. Moreover, the translucent material with which the filled holes are plugged allows light to pass through the filled holes. Thus, the filled holes may be used with a conventional optical recognition sensor to register the position of the strip during the IC package fabrication processes.

### BRIEF DESCRIPTION OF THE DRAWINGS

FIG. 1 is a top view of a prior art panel including a plurality of integrated circuit packages.

FIG. 2 is a top view of a strip including fiducial and guide pin notches according to embodiments of the present invention.

FIG. 3 is a cross-sectional view showing a completed IC package formed on a strip according to embodiments of the present invention.

FIG. 4 is a top view of a strip including fiducial notches and guide pin holes according to an alternative embodiment of the present invention.

FIG. 5 is a top view of a strip including fiducial holes and guide pin notches according to a further alternative embodiment of the present invention.

FIG. 6 is a top view of a strip including fiducial notches, guide pin notches and a plurality of integrated circuits which have been encapsulated in molding compound.

FIG. 7 is a top view of a strip including fiducial notches, guide pin notches and a plurality of integrated circuits which have been encapsulated in molding compound according to an alternative embodiment of the present invention.

FIG. 8 is a top view of a strip including fiducial holes and guide pin holes partially surrounded by molding compound during the encapsulation process.

FIG. 9 is a top view of a strip including fiducial holes partially surrounded by molding compound during the encapsulation process and guide pin notches according to an alternative embodiment of the present invention.

FIG. 10 is a top view of a strip including fiducial holes filled with solder mask or epoxy according to a further alternative embodiment of the present invention.

FIG. 11 is a top view of a strip including fiducial holes filled with solder mask or epoxy and partially covered with molding compound according to a further alternative embodiment of the present invention.

FIG. 12 is a top view of a strip including fiducial holes and guide pin holes partially surrounded by molding compound during the encapsulation process and integrated circuit package outlines formed to the edge of the molding compound.

FIG. 13 is a top view of a strip including fiducial holes and guide pin notches partially surrounded by molding compound during the encapsulation process, and integrated circuit package outlines formed to the edge of the molding compound.

FIG. 14 is a flow chart of a process for fabricating integrated circuit packages on a strip according to the present invention.

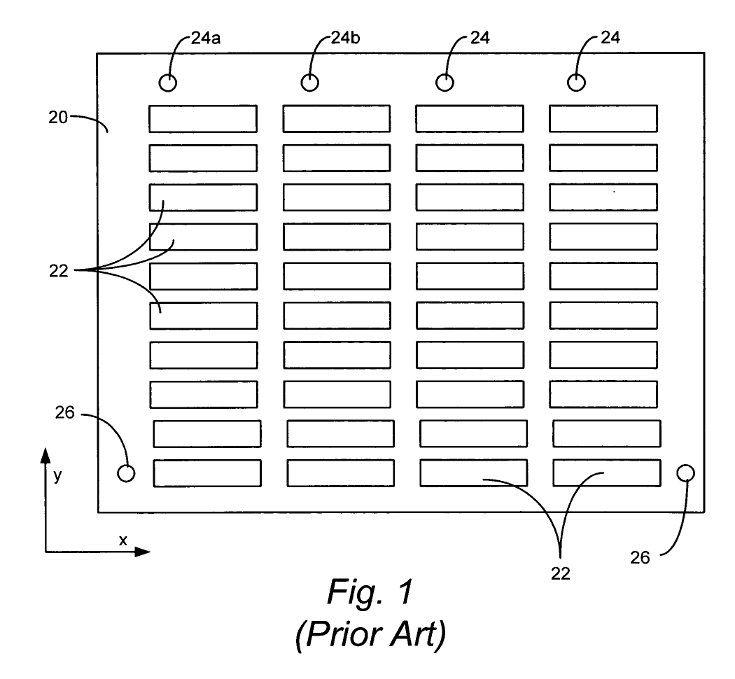

### DETAILED DESCRIPTION

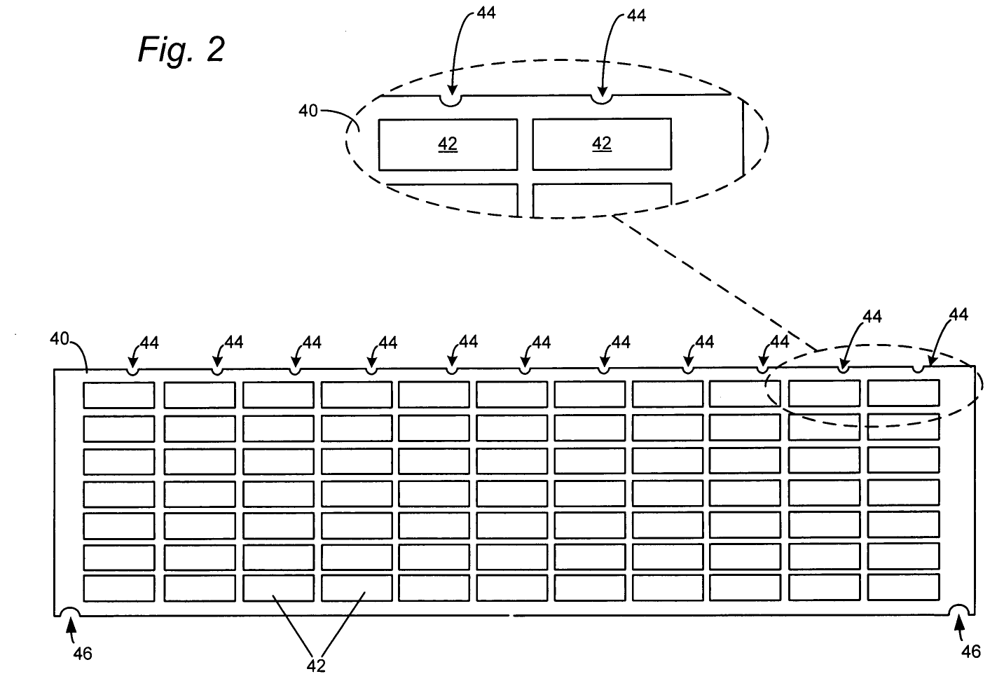

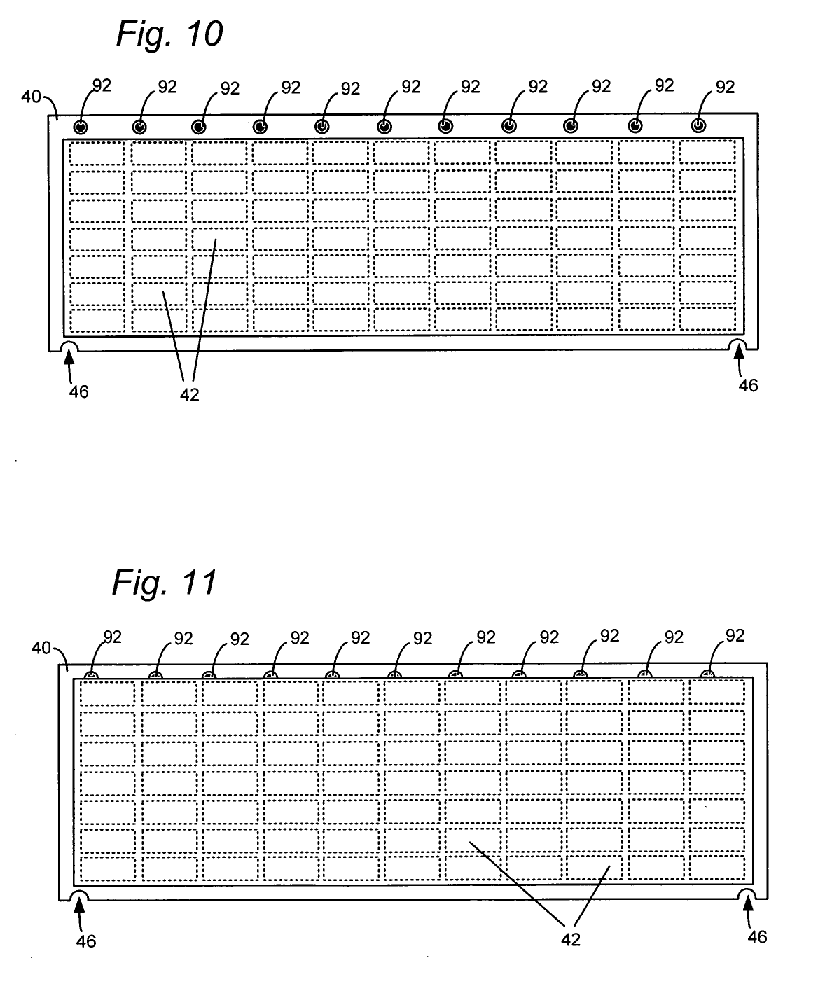

Embodiments of the invention will now be described with reference to FIGS. 2 through 14 which relate to strips for integrated circuit packages having a maximized usable area. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

Referring now to FIG. 2, there is shown a strip 40 including a plurality of IC package outlines 42 (only some of which are numbered in the figure). The strip 40 is shown prior to encapsulation. During the fabrication process, each package outline 42 will receive one or more semiconductor die and passive components as explained hereinafter.

The strip 40 includes a maximized usable area. In particular, in the embodiment of FIG. 2, the fiducial holes of the prior art are replaced by fiducial notches 44 formed in the outer periphery of the strip 40, at locations around the outer periphery. The strip 40 may alternatively or additionally include guide pin notches 46 formed in the outer periphery of the strip 40, which guide pin notches 46 replace the guide pin holes conventionally formed in a panel. While the fiducial notches 44 are shown along the top edge and the guide pin notches 46 are shown along the bottom edge, it is understood that the relative positions of the fiducial notches 44 and guide pin notches 46 may be reversed in alternative embodiments.

By forming the fiducial notches 44 and/or guide pin notches 46 in the outer periphery of the strip, the usable area on the strip on which IC package outlines 42 may be formed is increased. The fiducial notches 44 may be used with a conventional optical recognition sensor to register the position of the strip during the IC package fabrication processes. In particular, strip 40 may be mounted on an X-Y table capable of translating the strip 40 in an X-direction parallel to a top edge of the strip 40, and in a Y-direction parallel to a side edge of the strip 40. The optical recognition sensor includes a transmitter for emitting a beam along an edge of the strip 40 as the strip 40 translates, and a receiver capable of receiving the beam when the beam is not blocked by the strip 40. Normally, the edge of the strip 40 prevents the beam from being received within the receiver. However, when the beam encounters a notch 44, the beam passes through to the receiver to register a position of the strip. Thus, the notches 44 can be used in a manner similar to conventional fiducial holes for fabrication processes such as the die attach process.

In embodiments, the notches 44 may be semicircular, with a radius of 1.5 mm. It is understood that notches 44 may be other shapes in alternative embodiments, including but not limited to ovoid, triangular, square, rectangular, and trapezoidal. It is further understood that notches 44 may have a radius that is smaller or larger than 1.5 mm in alternative embodiments. Moreover, it is understood that notches 44 may be semicircular, but less than or more than one-half of a circle (i.e., an arclength of less than or more than 180°).

The guide pin notches 46 can be used to position with conventional pins used in fabrication processes including the encapsulation and singulation processes to register the position of the strip 40 as desired for the processes. In embodiments, the guide pin notches 46 may be semicircular, with a radius of 2 mm. It is understood that notches 46 may be other shapes in alternative embodiments, including but not limited to ovoid, triangular, square, rectangular, and trapezoidal. It is further understood that notches 46 may have a radius that is smaller or larger than 2 mm in alternative embodiments. Moreover, it is understood that notches 46 may be semicircular, but less than or more than one-half of a circle (i.e., an arclength of less than or more than 180°).

In the embodiment shown in FIG. 2, strip 40 may have 11 columns and 7 rows of IC package outlines 42 that are cut from strip 40 upon completion to form a plurality of portable memory devices or other semiconductor devices (77 such devices if each device passes inspection). It is understood that the fiducial notches 44 and/or the guide pin notches 46 may be used on different strips 40 having a wide variety of different IC package outline configurations. In one embodiment, the IC packages formed on strip 40 may be an LGA package for flash memory cards. It is understood that the IC package outline 42 may be for other types of semiconductor packages, including but not limited to for example BGA packages.

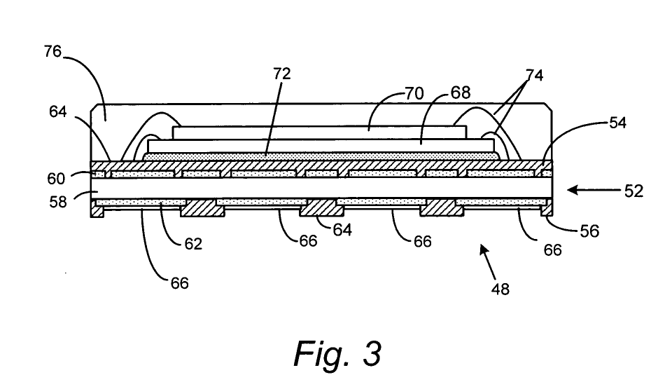

FIG. 3 is a cross-sectional view of IC package 48 that has been formed in a package outline 42 and singulated from strip 40. The IC package 48 may be configured as an LGA package. In such an embodiment, IC package 48 may include a substrate 52 having a top surface 54 and a bottom surface 56. Substrate 52 may be formed of a core 58, having a top conductive layer 60 formed on a top surface of the core 58, and a bottom conductive layer 62 formed on the bottom surface of the core. The core 58 may be formed of various dielectric materials such as for example, polyimide laminates, epoxy resins including FR4 and FR5, bismaleimide triazine (BT), and the like. Although not critical to the present invention, core 58 may have a thickness of between 40 microns (μm) to 200 μm, although the thickness of the core 58 may vary outside of that range in alternative embodiments. The core 58 may be ceramic or organic in alternative embodiments.

The conductive layers 60 and 62 may be formed of copper or copper alloys, plated copper or plated copper alloys, Alloy 42 (42Fe/58Ni), copper plated steel, or other metals and materials known for use on substrates. The layers 60 and 62 may have a thickness of about 10 μm to 24 μm, although the thickness of the layers 60 and 62 may vary outside of that range in alternative embodiments. The layers 60 and/or 62 may be etched to form electrical conductance patterns on the upper and/or lower surfaces 54, 56 of the substrate in a known manner to provide electrical connections between one or more die 68, 70, contact fingers 66 and/or other electronic components mounted on the surfaces of substrate 52. In embodiments including conductance patterns on both the top surface 54 and bottom surface 56, vias (not shown) may be provided to transmit electrical signals between the top and bottom surfaces of the substrate 52.

Once patterned, the top and bottom conductive layers may be laminated with a solder mask 64 as is known in the art, and one or more gold layers may be formed on portions of the bottom conductive layer 62 to define contact fingers 66 as is known in the art. Substrates including conductive layers which may be patterned in accordance with the present invention are available from Kinsus Interconnect Technology Corp., Santa Clara, Calif.

FIG. 3 further shows two stacked semiconductor die 68, 70 mounted on the top surface 54 of the substrate 52. Embodiments of the invention may alternatively include a single dice, and embodiments of the invention may alternatively include between 3 and 8 or more die stacked in an SiP, MCM or other type of arrangement. The die 68 may be mounted on the top surface 54 of the substrate 52 in a known adhesive or eutectic die bond process, using a known die attach compound 72. The die attach compound 72 may be for example any of various polymer adhesives containing conductive fillers for electrical conductivity. Such die attach compounds are manufactured for example by Semiconductor Packaging Materials, Inc. of Armonk, N.Y. The one or more die 68, 70 may be electrically connected to conductive layers 60, 62 of the substrate 52 by wire bonds 74 in a known wire bond process.

In embodiments where IC package 48 comprises an LGA package, bottom surface 56 of substrate 52 may include contact fingers 66. The contact fingers 66 are provided to establish an electrical connection in the finished device with contact pads of a host device (not shown) in a known manner when the contact fingers 66 are brought into pressure contact against the contact pads of the host device. While four contact fingers 66 are shown, it is understood that there may be more or less than four fingers in alternative configurations of the IC package 48. In an embodiment, there may be eight contact fingers.

After the wire bond process is completed, IC package 48 may be completed by encasing the top side of the IC package in a molding compound 76. Such molding compounds are available for example from Sumitomo Corp. and Nitto Denko Corp., both having headquarters in Japan. The bottom surface of the IC package outline containing the contact fingers 66 may be left exposed.

In embodiments of the invention, forming the fiducial notches 44 and/or guide pin notches 46 at the edges of strip 40 allows a greater number of the above-described IC package outlines to be formed on a strip of a given size as compared to conventional strips or panels. In particular, the size of the strip is generally selected by the semiconductor package manufacturer, and the size of the strip is not typically selected for a particular number of packages. The size of the strip is set, and then as many package outlines as will fit on that size are provided. If the density of the package outlines is maximized on a given size strip, it rarely works out that a whole number of package outlines fit on the strip. Instead, maximizing the density results in a given number of whole package outlines, and fractions of package outlines at the side and bottom edges. For example, a strip may fit 10½ package outlines across a length of the strip.

Obviously, ½ of a semiconductor package cannot be fabricated. Thus, conventionally, in this example, 10 such package outlines would be formed across the strip, and the 10 are spread out across the length of the strip (i.e., the boundary between package outlines may be increased).

However, by allowing package outlines to be fabricated closer to the edges of the strip, in an example where 10½ package outlines were previously attainable in a given size strip (which was conventionally reduced to 10 package outlines), the present invention allows the additional ½ package outline to fit on the strip, thus allowing 11 package outlines. These numbers are by way of example, but in general, the present invention may allow a fraction of a package outline to be turned into a whole package outline. The addition of even a single row and/or column of semiconductor package outlines within a given size strip would result in a tremendous increase in package outline yields.

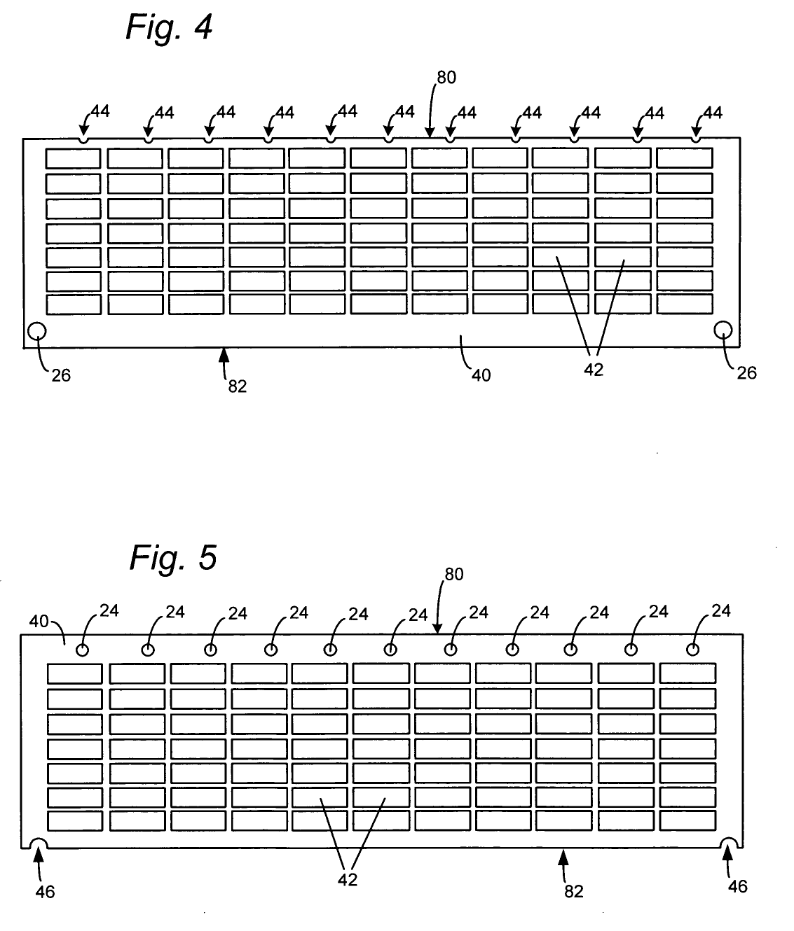

FIG. 2 illustrates an embodiment where both top and bottom edges of the strip 40 included notches 44. In an alternative embodiment shown in FIG. 4, one edge 80 of the strip 40 includes fiducial notches 44, while an opposite edge 82 includes conventional guide pin holes 26 as described in the Background of the Invention section. A further embodiment is shown in FIG. 5, where edge 80 includes conventional fiducial holes 24 and opposite edge 82 includes guide pin notches 46. It is understood that any one or more sides of the strip 40 may include notches, while the remaining sides include conventional holes, or no marks of any kind.

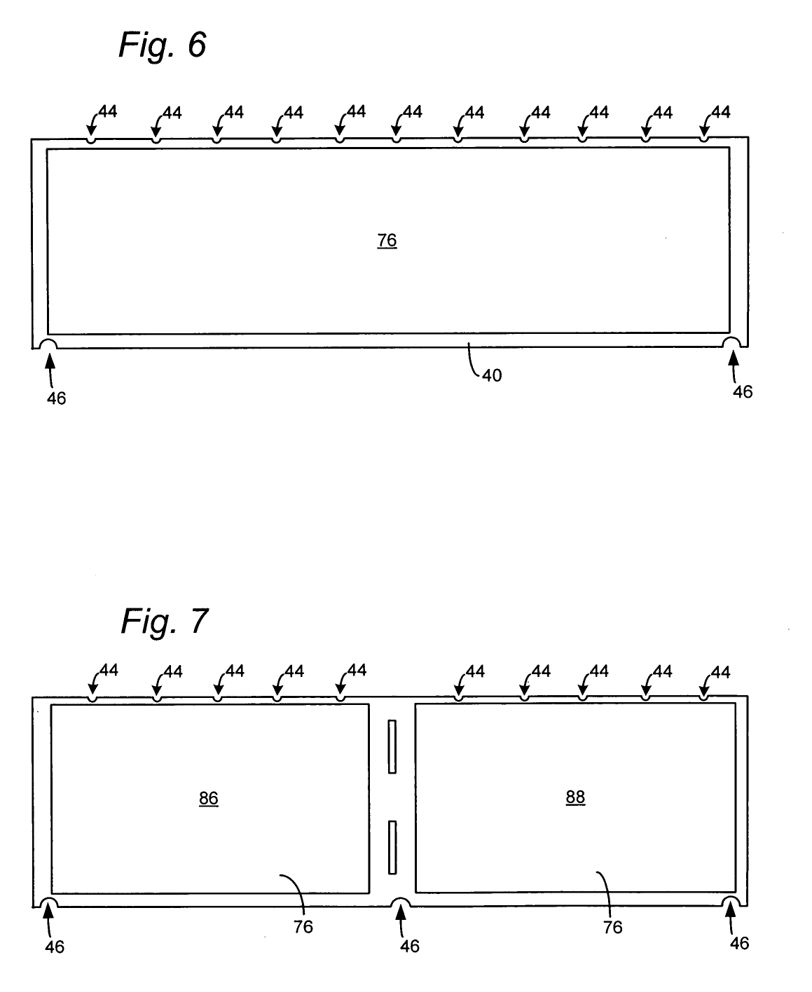

FIG. 6 is a top view of strip 40 including fiducial notches 44 and guide pin notches 46, where the strip 40 is encapsulated in molding compound 76 as described above. As previously described, the notches 44 and 46 allow the molding compound to be applied closer to the edges of the strip 40 than in conventional molded strips. In the embodiment of FIG. 6, molding compound 76 is applied across substantially all of strip 40 to define a single block of package outlines 42. In an alternative embodiment shown in FIG. 7, the molding compound 76 is applied in two distinct areas 86 and 88 on the strip 40 to define two blocks of package outlines 42, separated by a boundary region 90. As there are no package outlines 42 in the boundary region 90, the fiducial notch 44 at the boundary region 90 may be omitted. An additional guide pin notch 46 may be added to the strip 40 to indicate to the fabrication equipment the start of the second distinct area 88. As indicated above, the fiducial notches 44 or the guide pin notches 46 may be replaced with fiducial holes 24 or guide pin holes 26 as in the prior art.

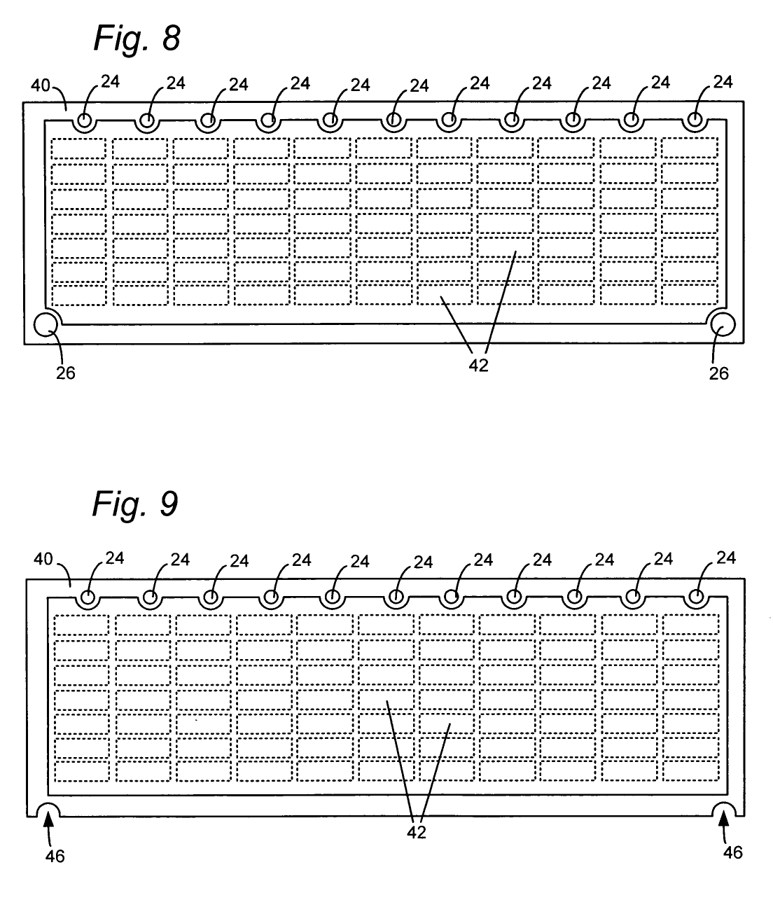

In a further embodiment shown in FIG. 8, the strip 40 may include the conventional fiducial holes 24 and/or guide pin holes 26 described above. However, in this embodiment, the molding compound 76 may be applied onto strip 40 closer to the edges of the strip as compared to the prior art so as to at least partially surround the fiducial holes 24 and/or the guide pin holes 26. In an embodiment, the molding compound 76 may extend toward an edge so as to surround one-half of a fiducial hole 24. It is understood that the molding compound may surround more or less than one-half of each fiducial hole 24 in alternative embodiments. In an embodiment, the molding compound may extend toward an edge so as to surround one-quarter of a guide pin hole 26. It is understood that the molding compound may surround more or less than one-quarter of each guide pin hole 26 in alternative embodiments.

The embodiment shown in FIG. 8 may be combined with the embodiment of FIG. 2. Thus, as shown in FIG. 9, the strip 40 may include fiducial holes 26 partially surrounded by molding compound 76, and guide pin notches 46. Alternatively, the strip 40 may include fiducial notches 44 as shown in FIG. 2, and guide pin holes 26 partially surrounded by molding compound 76. In a further embodiment, the molding compound 76 may be applied onto strip 40 so as to entirely surround one or more of the fiducial holes 24 and/or guide pin holes 26. In a still further embodiment, the strip 40 may include fiducial notches 44 and/or guide pin notches 46, which notches 44 and/or 46 are at least partially surrounded by molding compound 76 so that the molding compound extends to, or substantially to, one or more edges of strip 40.

In the embodiments described above, fiducial notches 44 and holes 24 are openings formed in the substrate. In a further embodiment shown in FIGS. 7 and 8, fiducial holes 92 may be formed in the substrate, and then filled with a translucent material. The translucent material may be any of various materials, including for example translucent solder mask and/or translucent epoxy. Other translucent materials are contemplated. The filled fiducial holes 92 may be a variety of shapes, including but not limited to round, ovoid, triangular, square, rectangular, and trapezoidal.

Positioning unfilled holes 92 near the edge of the strip increases the risk that cracks will form between the unfilled holes and the strip edge. By filling the fiducial holes with material, the structural integrity of the strip is improved, and the filled holes 92 may be placed close to or at the edge of the strip without risk of the strip cracking. Moreover, the translucent material with which filled holes 92 are plugged allows light to pass through the holes 92. Thus, the filled holes may be used with a conventional optical recognition sensor to register the position of the strip during the IC package fabrication processes. In a further alternative embodiment shown in FIG. 11, the filled holes 92 may be partially covered with molding compound.

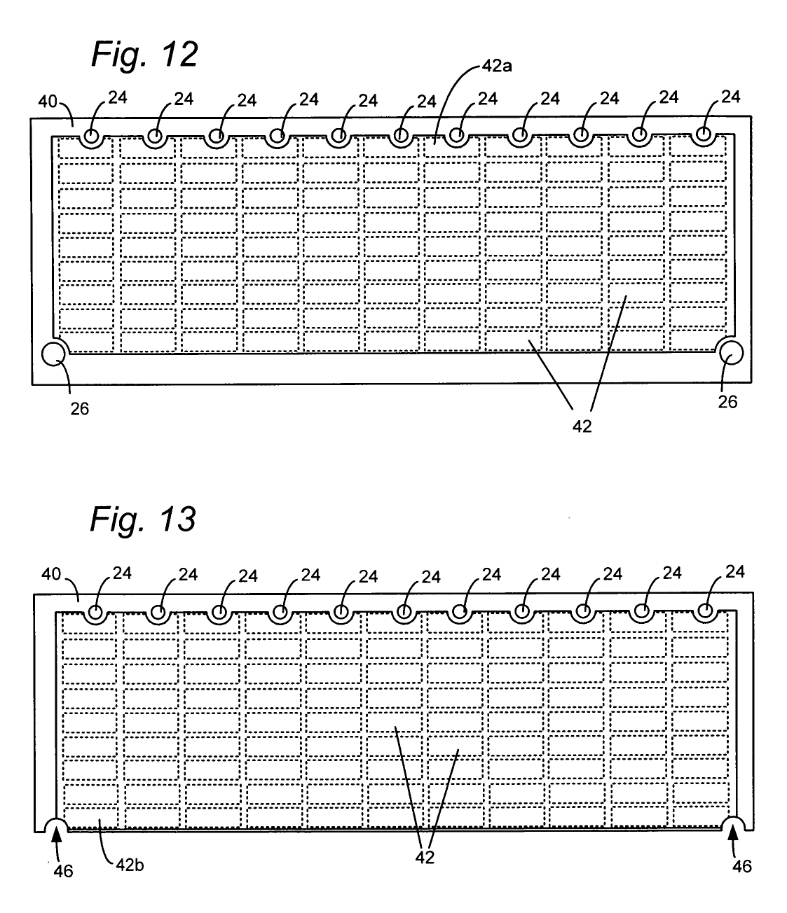

FIGS. 12 and 13 illustrate a further embodiment of the invention where the IC package outlines 42 extend to the edge of the mold cap. As seen in FIGS. 12 and 13, this will result in some of the package outlines 42, for example package outline 42a in FIG. 12 and package outline 42b in FIG. 13, having a notched portion where the package outlines and mold cap partially surround the holes and/or notches. In such embodiments, the IC packages formed at package outlines 42 would each have a blank area corresponding to notched areas seen at package outline 42a and 42b. In alternative embodiments, only the boundary rows or individual package outlines actually requiring notched areas would have blank areas in the IC packages corresponding to the notched areas. It is understood that the embodiment shown in FIGS. 12 and 13 may be combined with any of the previously disclosed embodiments.

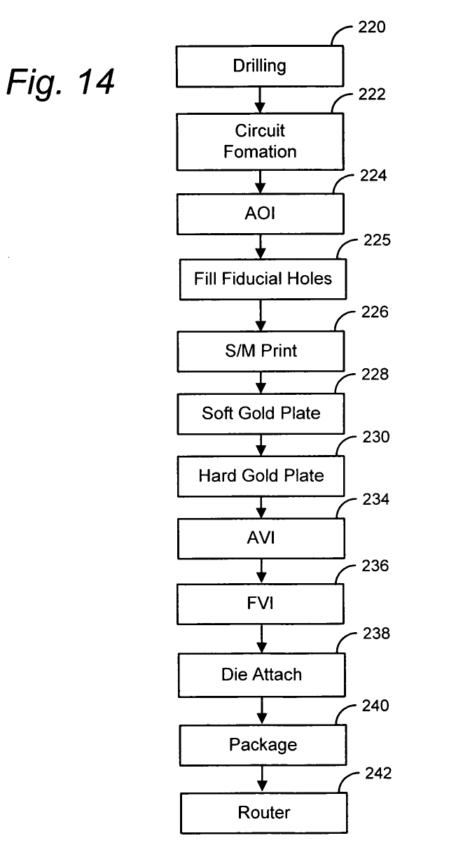

A process for forming the finished IC package 48 is explained with reference to the flow chart of FIG. 14. In step 220, the strip 40 (which starts out as bare substrate 52) is drilled and/or cut to provide the fiducial holes, fiducial notches, guide pin holes and/or guide pin notches as described above. Using the fiducial notches and/or holes to position the substrate in a processing tool, the conductance pattern is then formed on the respective surfaces of the strip in step 222 using, for example, photolithography and etching techniques. The patterned strip is then inspected in an automatic optical inspection (AOI) in step 224. In embodiments where the fiducial holes 92 are plugged with epoxy or solder mask, the holes 92 may be filled in a step 225. In embodiments where the holes are not filled, step 225 may be omitted. Once inspected, the solder mask is applied to the strip in step 226. It is contemplated that, in embodiments where holes 92 are filled with solder mask, the steps 225 and 226 may be combined into a single step.

After the solder mask is applied, the contact fingers are completed. A soft gold layer is applied over certain exposed surfaces of the conductive layer on the bottom surface of the substrate, as for example by thin film deposition, in step 228. As the contact fingers are subject to wear by contact with external electrical connections, a hard layer of gold may be applied, as for example by electrical plating, in step 230. It is understood that a single layer of gold may be applied in alternative embodiments. The patterned substrate is then inspected and tested in an automated step (step 234) and in a final visual inspection (step 236) to check electrical operation, and for contamination, scratches and discoloration. The strip is then sent through the die attach process in step 238 to attach one or more die to each package outline 42. The substrate and die are then packaged in step 240 in a known injection mold process to form a JEDEC standard (or other) package outline. A router or other cutting device then separates the strip into individual IC packages in step 242. It is understood that the strip 40 may be formed by other processes in alternative embodiments.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A strip on which a plurality of integrated circuit package outlines are capable of being fabricated within a plurality of process tools, the strip comprising:
one or more notches formed in an outer edge of the strip, the one or more notches allowing registration of a position of the strip within at least one process tool of the plurality of process tools.

2. A strip as recited in claim 1, the one or more notches comprising one or more fiducial notches operable with an optical recognition sensor.

3. A strip as recited in claim 1, the one or more notches comprising one or more guide pin notches operable with a guide pin.

4. A strip as recited in claim 1, the strip further comprising one or more holes spaced inward from an outer edge of the strip, the one or more holes allowing registration of a position of the strip within at least one process tool of the plurality of process tools.

5. A strip as recited in claim 4, wherein the edge including the one or more notches is opposite the edge including the one or more holes.

6. A strip as recited in claim 4, the strip further comprising molding compound encasing integrated circuit packages on at least one side of the strip, the molding compound applied to at least partially surround the one or more holes in the strip.

7. A strip as recited in claim 1, wherein the one or more notches are semicircular in shape.

8. A strip as recited in claim 7, wherein the one or more notches have a radius of approximately 1.5 millimeters.

9. A strip as recited in claim 7, wherein the one or more notches have an arclength of approximately 180°.

10. A strip as recited in claim 1, wherein the one or more notches are at least one of ovoid, triangular, square, rectangular, and trapezoidal in shape.

11. A strip as recited in claim 1, wherein the strip includes eleven columns and seven rows of integrated circuit package outlines.

12. A strip as recited in claim 11, wherein the one or more notches comprise one fiducial notch for every column of integrated circuit package outlines.

13. A strip on which a plurality of integrated circuit packages are capable of being fabricated within a plurality of process tools, the strip including at least one hole spaced inward from an edge of the strip for allowing registration of a position of the strip within at least one process tool of the plurality of process tools, the strip comprising:
a molding compound for encasing at least one side of the plurality of integrated circuit package outlines, the molding compound at least partially surrounding the at least one hole.

14. A strip as recited in claim 13, the at least one hole comprising one or more fiducial holes operable with an optical recognition sensor.

15. A strip as recited in claim 13, the at least one hole comprising one or more guide pin holes operable with a guide pin.

16. A strip as recited in claim 13, wherein the molding compound partially surrounds the at least one hole.

17. A strip as recited in claim 13, wherein the molding compound completely surrounds the at least one hole.

18. A strip as recited in claim 13, wherein the strip includes eleven columns and seven rows of integrated circuit package outlines.

19. A strip as recited in claim 18, wherein the at least one hole comprises one fiducial hole for every column of integrated circuit package outlines.

20. A flash memory formed from a strip including a plurality of integrated circuit package outlines, the strip from which the flash memory is formed comprising:
one or more fiducial notches formed in an outer edge of the strip, the one or more fiducial notches allowing registration of a position of the strip within at least one process tool of the plurality of process tools.

21. A flash memory as recited in claim 20, the strip further comprising one or more fiducial holes spaced inward from an outer edge of the strip.

22. A flash memory as recited in claim 21, the strip further comprising molding compound encasing integrated circuit packages on at least one side of the strip, the molding compound applied to at least partially surround the one or more fiducial holes in the strip.

23. A flash memory as recited in claim 20, wherein the strip includes eleven columns and seven rows of integrated circuit package outlines.

24. A flash memory as recited in claim 23, wherein the one or more fiducial notches comprise one fiducial notch for every column of integrated circuit package outlines.

25. A strip on which a plurality of integrated circuit package outlines are capable of being fabricated within a plurality of process tools, the strip comprising:
one or more holes formed in an outer edge of the strip, the one or more holes allowing registration of a position of the strip within at least one process tool of the plurality of process tools, and the one or more holes being filled with a translucent material.

26. A strip as recited in claim 25, wherein the translucent material is an epoxy.

27. A strip as recited in claim 25, wherein the translucent material is solder mask.

28. A strip as recited in claim 25, the strip further comprising molding compound encasing integrated circuit packages on at least one side of the strip, the molding compound applied to at least partially cover the one or more filled holes in the strip.

29. A flash memory formed from a strip including a plurality of integrated circuit package outlines, the strip from which the flash memory is formed comprising: one or more holes formed in an outer edge of the strip, the one or more holes allowing registration of a position of the strip within at least one process tool of the plurality of process tools, and the one or more holes being filled with a translucent material.

30. A flash memory as recited in claim 29, wherein the translucent material is an epoxy.

31. A flash memory as recited in claim 29, wherein the translucent material is solder mask.

32. A flash memory as recited in claim 29, the strip further comprising molding compound encasing integrated circuit packages on at least one side of the strip, the molding compound applied to at least partially cover the one or more filled holes in the strip.

33. A method of identifying a position of a strip within a processing tool for forming a portion of an integrated circuit on the strip, the method comprising the steps of:
(a) translating the strip in a first direction;
(b) transmitting a beam from a transmitter along an edge of the strip as the strip translates in said step (a); and
(c) registering a position of the strip when the beam from the transmitter passes through an interruption in an edge of the strip and is received within a receiver.

34. A method as recited in claim 33, wherein said step (c) of registering a position of the strip when the beam from the transmitter passes through an interruption in an edge of the strip comprises the step of the beam passing through a notch formed in an edge of the strip.
